(19) United States
(12) Patent Application Publication
(10) Pub. No.: US 2024/0289893 A1
(43) Pub. Date: Aug. 29, 2024

(54) PREDICTIVE REVENUE DISTRIBUTION USING A REAL-TIME PAYMENT NETWORK

(71) Applicant: American Express Travel Related Services Company, Inc., New York, NY (US)

(72) Inventor: Dean Ernest Arthur NICOLSON, Sydney (AU)

(73) Assignee: American Express Travel Related Services Company, Inc., New York, NY (US)

(21) Appl. No.: 18/113,806

(22) Filed: Feb. 24, 2023

(51) Int. Cl. G06Q 40/12; G06Q 20/10

(52) U.S. Cl. CPC G06Q 40/12; G06Q 20/102

(57) ABSTRACT

Disclosed herein are system, method, and computer program product embodiments for providing predictive revenue distribution using machine learning and a Real-Time Payment (RTP) network. A revenue distribution system may train and apply a machine learning model to merchant transaction records to generate a predicted revenue amount. The revenue distribution system may deposit predicted revenue amounts to provide predictive funding for merchant accounts. For example, this may provide same-day and/or next-day funding. The revenue distribution system may account for differences in predicted revenue amounts and actual transaction amounts by adjusting the deposits of subsequent days. The revenue distribution system may also account for different periods of time, such as several days, a week, or longer. The revenue distribution system may also detect potentially fraudulent transaction amounts and/or may aid in monitoring business performance based on a detected difference between a predicted revenue amount and a provided transaction amount.

### BACKGROUND

### Field

This field is generally related to using machine learning to provide predictive revenue deposits using a Real-Time Payment (RTP) network.

### Related Art

As transaction technology continues to evolve, businesses may still encounter delays in receiving settlement funding for completed transactions. While larger merchants or businesses may be able to maintain reserve funding or obtain lines of credit to account for these delays, small or medium sized business may be more sensitive to the effects of a delay. For example, a delay in funding completed transactions may prevent such businesses from having enough capital to purchase more products for sale. Receiving funding 24 or 48 hours after a sale is completed may have detrimental effects on business. In this manner, conventional computing processes for dispersing funding for completed transactions are inefficient.

### BRIEF SUMMARY

Disclosed herein are system, apparatus, device, method and/or computer program product embodiments, and/or combinations and sub-combinations thereof, for providing predictive revenue distribution using machine learning and a Real-Time Payment (RTP) network.

In some embodiments, a revenue distribution system may generate a predicted revenue amount for a merchant account. The revenue distribution system may use a predictive revenue service implementing a machine learning or artificial intelligence model to determine a revenue forecast corresponding to the merchant account. The predicted revenue amount may correspond to a time period and/or may correspond to a particular day. For example, the predicted revenue amount may predict that a merchant account may complete $2,000 in sales in a particular day.

With the predicted revenue amount, the revenue distribution system may provide a predicted revenue deposit in the merchant account. This deposit may be in advance of transaction completion. For example, the predicted revenue deposit may be dispersed in the morning or the day before the particular day considered. For example, if the predicted revenue amount is $2,000, the revenue distribution system may distribute this amount to the merchant account prior to the merchant completing an amount of transactions meeting or exceeding $2,000. This deposit may be a same day cash flow and/or a next day cash flow. In some embodiments, the prediction and/or the deposit of a predicted revenue amount may occur further in advance as well. For example, the revenue distribution system may provide multiple days or a week of deposits for the merchant account.

To generate the predicted revenue amount, the revenue distribution system may train a machine learning model using merchant record data. In some embodiments, this merchant record data may be a daily transaction amount completed by the merchant. Using merchant record data, the machine learning model may account for periodic transaction amounts to predict a revenue amount for a particular time period. For example, the machine learning model may predict an average amount based on an average daily transaction amount calculated from the merchant record data.

In some embodiments, the machine learning model may also account for other factors when determining a predicted revenue amount. For example, the machine learning model may consider factors specific to the merchant and/or factors based on merchant records of other similar merchants. For example, the machine learning model may consider the industry of business for the merchant, the merchant's size, and/or average income. The machine learning model may also be trained to identify seasonal patterns based on reported revenues. An example of a seasonal pattern may be the detection of a steady amount of revenue but then a large increase in revenue around the holidays or Christmas time. Similarly, a merchant may be an ice cream store, which may experience an increase in revenue over the summer months. In some embodiments, the machine learning model may track temperature, weather, geography, and/or other factors to determine a predicted revenue amount for the merchant account.

The machine learning model may also factor records corresponding to other merchants. These may be merchants and/or merchant records designated by the revenue distribution system as being similar to a particular merchant account. For example, the other merchants may share a common industry of business and/or share a common merchant category code as categorized by the revenue distribution system. This merchant category code may characterize the merchant, such as indicating whether the merchant is a gas station, retail store, hairdresser, service provider, and/or other merchant categories. In some embodiments, the machine learning model may also examine merchant records from similar merchants in a geographic area. This may be a postal code or zip code and/or a particular geographic region. For example, if the merchant is a coffee cart in a particular area, the machine learning model may examine merchant records for other businesses in that area to identify potential trends in transaction revenues.

In some embodiments, the revenue distribution system may access first party data collected from merchants and/or customers. For example, as previously explained, merchants may provide data corresponding to completed transactions. The revenue distribution system may also access data from customers to determine purchasing trends. For example, the revenue distribution system may access credit card data from the customer and/or credit card revenue received by the merchants. The machine learning model may also account for this customer data based on geographic region.

In some embodiments, the revenue distribution system may also access banking information provided by a merchant if given permission. This may aid in providing revenues beyond the revenue specifically tracked by the revenue distribution system. In some embodiments, the banking information may also be provided and/or access through an Open Banking framework and/or other Open Finance framework. These frameworks may be regulated. In some embodiments, the information may be provided and/or accessed based on provided consent for third party data sharing. This may depend on jurisdictional regulations.

After dispersing a predicted revenue amount, the revenue distribution system may also track the actual amount for the transactions completed by the merchant. This may be a daily submission provided by the merchant. The revenue distribution system may determine the difference between the predicted revenue amount, which may have been previously deposited into the merchant account, and the actual amount. The revenue distribution system may retrain the machine learning model based on the actual amount and/or difference to increase accuracy in predictions of future revenue amounts.

To account for the difference in predicted and actual revenue amount for a particular time period, the revenue distribution system may adjust a subsequent predicted amount to account for the difference. For example, the revenue distribution system may deposit a predicted revenue amount daily. For a first day, the machine learning model may predict that a merchant account will receive $1,000 in transaction amounts. The revenue distribution system may deposit $1,000 into the merchant account at the beginning of the day based on this prediction. When the actual transaction amount is less than the predicted revenue amount, the revenue distribution may reduce the second day's amount by the difference. For example, the actual transaction amount for the first day may be $800. This may result in a difference of $200. The revenue distribution system may predict a $1,500 revenue amount for the second day. To account for the first day's difference, the revenue distribution system may deposit $1,300 into the merchant account on the second day. In this manner, the revenue distribution system may account for differences and adjust to account for the actual transaction amount.

In the scenario where the predicted revenue amount is less than the actual transaction amount, the revenue distribution system may provide the difference so that the merchant account receives the actual transaction amount. For example, if $1,000 has been deposited into the merchant account but the merchant account receives $1,200 in transactions for a particular day, the revenue distribution system may provide the additional $200 to account for the difference. In some embodiments, this may occur at the close of business, end of the day, and/or with the next day's predicted revenue amount.

In this manner, the revenue distribution system may provide an increase in speed for distributing funding for a merchant account. The predictive nature of the machine learning may provide a deposit that is better than real-time settlement. That is, the predicted amount may be deposited before actual transactions have occurred. To further increase the speed of deposit, the revenue distribution system may use a Real-Time Payment (RTP) network to communicate with banks. The RTP network may provide real-time payments from banking institutions. The revenue distribution system may use an application programming interface (API) to connect to and access banking systems via the RTP network. RTP network payments may clear and settle individually in real time with immediate finality. In contrast, same day Automated Clearing House (ACH) payments may be cleared in batches and settle after payments clear. In this manner, RTP network access may allow the revenue distribution system to more quickly obtain funds for predictive revenue deposits. The revenue distribution system therefore provides a RTP portal for merchant account deposits. This may further increase the speed of deposit and allow for same day and/or next day predictions to be performed and executed. This may allow for minus-one-day settlements and/or allow a merchant to receive tomorrow's takings today.

The machine learning model may also be used to detect potential fraudulent merchant activity. Because the machine learning model has been trained to predict a particular revenue amount, if a merchant account reports an amount that exceeds a particular expected threshold, the revenue distribution system may trigger a review of the merchant's transaction record. This may generate a request for additional approval before providing an additional deposit. Similarly, if the revenue distribution system detects an actual transaction amount that is lower than a threshold, the revenue distribution system may also trigger an additional review. This data may indicate potential fraud and/or difficulties that a merchant may be experiencing with business performance. The revenue distribution system may generate an alert to the merchant in this case. In this manner, the predictive revenue amount may allow for fraud detection and/or provide additional business performance data for a merchant.

### BRIEF DESCRIPTION OF THE DRAWINGS

The accompanying drawings are incorporated herein and form a part of the specification.

FIG. 1 depicts a block diagram of a predictive revenue environment, according to some embodiments.

FIG. 2 depicts a flowchart illustrating a method for generating and depositing a predicted revenue amount, according to some embodiments.

FIG. 3A depicts a flowchart illustrating a method for processing a transaction amount that is greater than a predicted revenue amount, according to some embodiments.

FIG. 3B depicts a flowchart illustrating a method for processing a transaction amount that is less than a predicted revenue amount, according to some embodiments.

FIG. 4 depicts a flowchart illustrating a method for triggering a transaction review, according to some embodiments.

FIG. 5 depicts a block diagram of a graphical user interface (GUI) displaying revenue trends, according to some embodiments.

FIG. 6 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for providing predictive revenue distribution using machine learning and a Real-Time Payment (RTP) network. As further described below, a revenue distribution system may train and apply a machine learning model to various factors corresponding to a merchant's revenue to generate a predicted revenue amount. The revenue distribution system may periodically deposit predicted revenue amounts prior to the completion of transactions to provide predictive funding for merchant accounts. For example, this may provide same-day funding which may occur at the beginning of the day before transactions have been completed and/or next-day funding which may be provided on a previous day. The revenue distribution system may account for differences in predicted revenue amounts and actual transaction amounts by adjusting the deposits of subsequent days. The revenue distribution system may also account for different periods of time, such as several days, a week, or longer. The revenue distribution system may also detect potentially fraudulent transaction amounts and/or may aid in monitoring business performance.

Various embodiments of these features will now be discussed with respect to the corresponding figures.

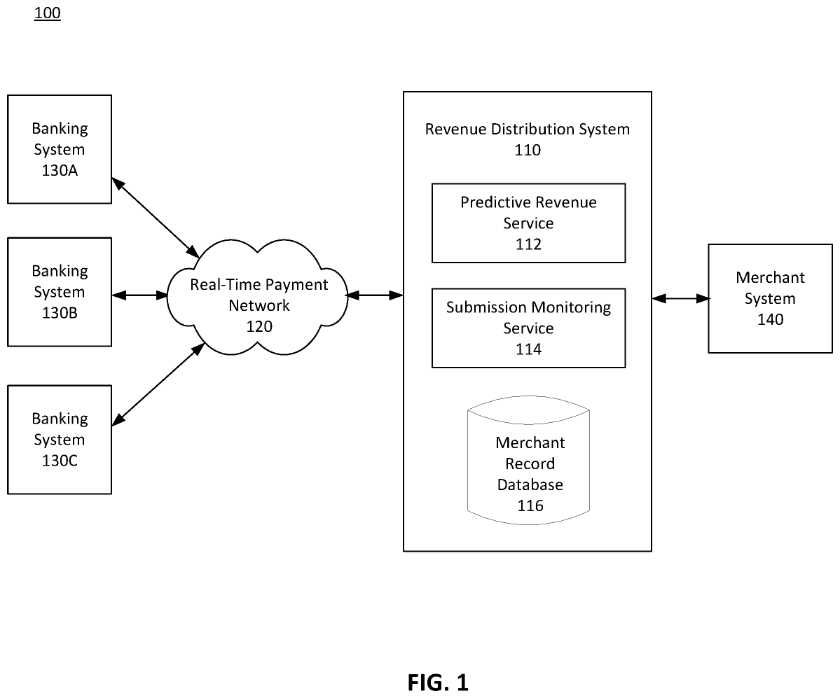

FIG. 1 depicts a block diagram of a predictive revenue environment 100, according to some embodiments. Predictive revenue environment 100 includes revenue distribution system 110, Real-Time Payment (RTP) network 120, banking systems 130A, 130B, 130C, and/or merchant system 140. Revenue distribution system 110 may include predictive revenue service 112, submission monitoring service 114, and/or merchant record database 116.

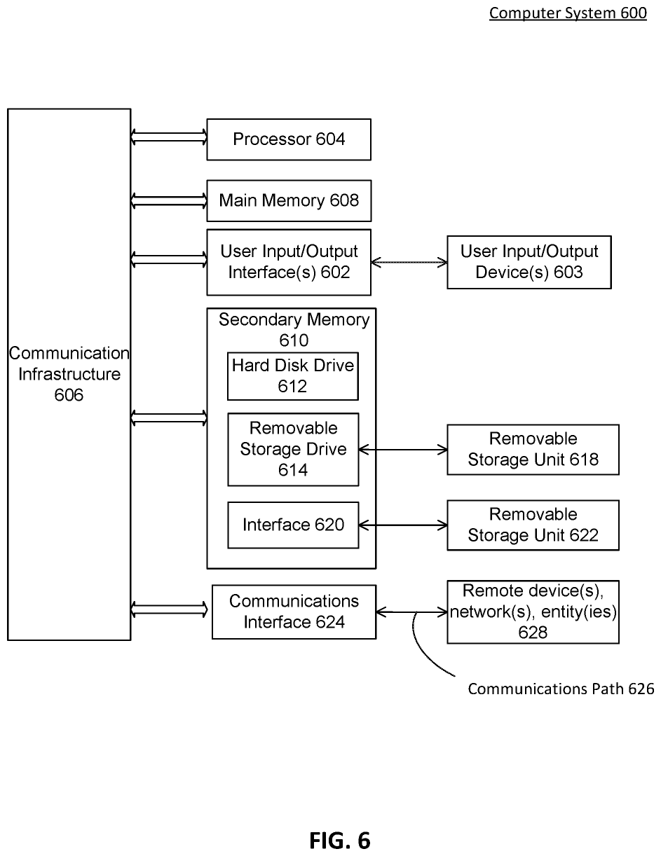

Revenue distribution system 110 may be a computer system such as computer system 600 described with reference to FIG. 6. For example, revenue distribution system 110 may be implemented using one or more servers and/or databases. Revenue distribution system 110 may generate predicted revenue amounts for a particular merchant based on factors specific to the particular merchant and/or factors based on merchant records of other similar merchants. To generate this predicted revenue amount, predictive revenue service 112 may analyze merchant transaction records stored in merchant record database 116. Merchant record database 116 may store merchant data corresponding to merchant system 140 and/or other merchant records. For example, merchant record database 116 may store a set of transaction records corresponding to one or more merchant accounts. The set of transaction records may correlate a plurality of time periods with respective transaction amounts.

Predictive revenue service 112 may generate a predicted revenue amount corresponding to a particular time period based on the merchant data stored in merchant record database 116. For example, the time period may be a daily predicted revenue amount. Predictive revenue service 112 may use a machine learning model that has been trained using the merchant data. For example, the machine learning model may be trained to predict trends based on a history of completed transaction amounts for a particular merchant. The machine learning model may also consider factors including the industry of business for the merchant, seasonal patterns of reported revenue, temperature, weather, geography, and/or other factors. The machine learning model may also consider records of other similar merchants and/or customer records. For example, records of other similar merchants and/or customer records may be accessed to supplement the merchant records and/or if there are too few merchant records.

The machine learning model may be trained to receive a particular temporal input and provide a predicted revenue amount for that time period. For example, when provided with a particular calendar date, the machine learning model may provide a predicted revenue amount for the merchant for that particular calendar date. Similarly, the input may be a range of dates. In this case, the machine learning model may provide a predicted revenue amount for the range of dates.

The machine learning algorithm used by predictive revenue service 112 may be trained using the records. In some embodiments, this training may occur in a supervised and/or an unsupervised manner. For example, the machine learning algorithm may include a cluster analysis and/or may include an artificial intelligence model. In some embodiments, a machine learning algorithm may be a mathematical model based on sample data. The mathematical model may be trained using a sample set of data. The model may be used to make predictions and/or decisions without being explicitly programmed to perform a task. A machine learning algorithm may be trained using supervised learning, unsupervised learning, and/or semi-supervised learning. For example, input data may include labeled and/or unlabeled training data. The model may be prepared by deducing structures present in the training data. For example, the model may extract general rules to reduce redundancy and/or organize data by similarity.

The training may include clustering, dimensionality reduction, and/or association rule learning. The algorithm may also use an Apriori algorithm and/or a K-Means algorithm. Other machine learning algorithms may also be used, such as, for example, a regression algorithm, an instance-based algorithm, a regularization algorithm, a decision tree algorithm, a Bayesian algorithm, a clustering algorithm, an association rule learning algorithm, a neural network, a deep learning algorithm, a dimensionality reduction algorithm, an ensemble algorithm, and/or other machine learning or artificial intelligence models. These algorithms may be used separately and/or in combination. As previously explained, the machine learning model may consider and/or weigh factors specific to the merchant account and/or other factors based on other similar merchants to generate a predicted revenue amount.

After applying the machine learning model, predictive revenue service 112 may generate a predicted revenue amount corresponding to a particular time period. For example, predictive revenue service 112 may predict a revenue of $1,000 for a particular day. With this prediction, revenue distribution system 110 may interface with Real-Time Payment (RTP) network 120 to transfer the predicted revenue amount to a merchant account. For example, revenue distribution system 110 may transfer funding from an account corresponding to revenue distribution system 110 to an account corresponding to merchant system 140. These accounts may be bank accounts managed by one or more banking systems 130.

After identifying the merchant account for depositing the predicted revenue amount, revenue distribution system 110 may access a banking system 130 via RTP network 120. For example, this access may be an API call issued by revenue distribution system 110 to deposit the predicted revenue amount to the merchant account. Funding may be dispersed via RTP network 120. This transfer of funding may be faster than an ACH transfer and/or may result in merchant system 140 accessing the funds in a faster manner. In some embodiments, revenue distribution system 110 may use RTP network 120 to direct funding from the account corresponding to revenue distribution system 110 into the account corresponding to merchant system 140. For example, if the revenue distribution system 110 account corresponds to banking system 130A and the merchant system 140 account corresponds to banking system 130B, revenue distribution system 110 may direct a transfer from banking system 130A to banking system 130B to provide the predicted revenue amount. Revenue distribution system 110 may specify the appropriate account numbers for this transfer.

By using RTP network 120 to perform this fund transfer, revenue distribution system 110 may quickly execute and/or verify the transfer of funds corresponding to the predicted revenue amount. This fast execution and verification may allow revenue distribution system 110 to quickly execute deposits based on predictions generated by predictive revenue service 112. Predictive revenue service 112 may also modify a predicted revenue amount depending on whether a previous day's actual transaction amount was more or less than the previous day's predicted revenue amount.

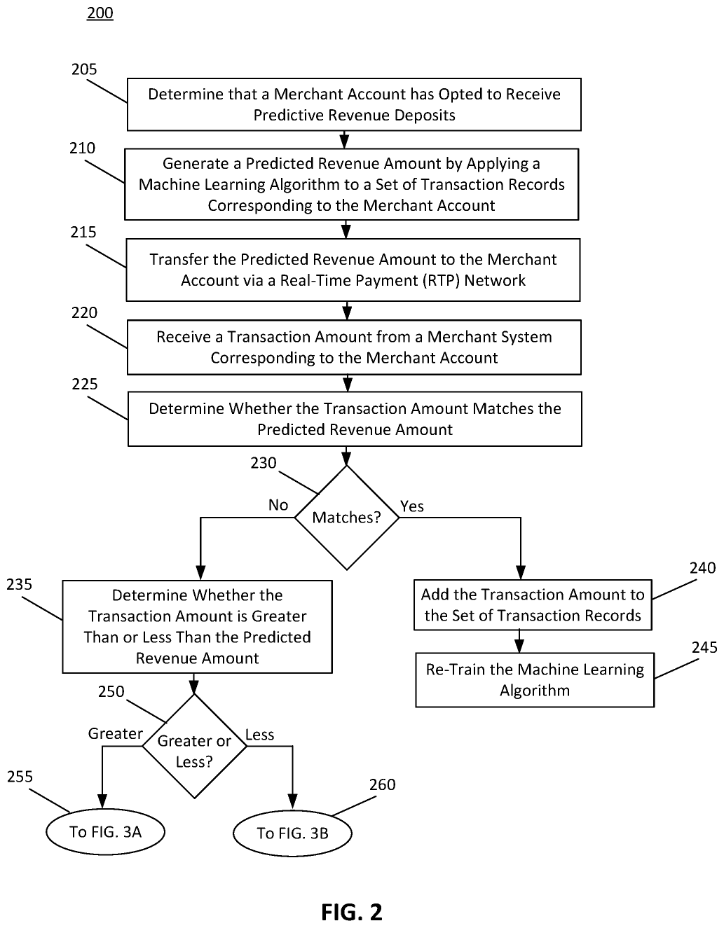

Revenue distribution system 110 may also include submission monitoring service 114. Submission monitoring service 114 may receive data from merchant system 140 indicating the actual transaction amounts logged by merchant system 140. For example, merchant system 140 may provide a daily accounting of completed transactions to submission monitoring service 114. As further described with reference to FIGS. 2, 3A-3B, and 4, submission monitoring service 114 may process the received transaction data to determine whether the actual transaction amount matches the predicted revenue amount. If so, the submission monitoring service 114 may add the transaction data to merchant record database 116 and/or re-train the machine learning model used by predictive revenue service 112. This re-training may aid in providing greater accuracy for the machine learning model by using feedback to adjust the algorithm.

When submission monitoring service 114 detects that the actual transaction amount differs from the predicted revenue amount, submission monitoring service 114 may determine the difference between the two amounts. Depending on the magnitude of the difference, submission monitoring service 114 may trigger a transaction review to potentially detect fraud and/or business performance issues. For example, if the actual transaction amount is greater than the predicted revenue amount by a threshold and/or if the difference exceeds a threshold, submission monitoring service 114 may trigger a review. This may appear as a graphical user interface (GUI) notification and/or a message to an administrator of revenue distribution system 110. For example, the message may be an email and/or a message to a user account. The message may be directed to a client manager and/or a merchant partnership manager. For example, this may be directed to an email account and/or user account corresponding to such roles. The message may inform the recipient of the irregularity and/or provide contact information for the merchant. The message may also indicate manual steps for the recipient to take to contact the merchant. In some embodiments, when the actual transaction amount is less than the predicted revenue amount, a review may also be triggered. For example, submission monitoring service 114 may inform merchants of potential business performance issues if there is a trend of not meeting the predicted revenue amount.

Transaction amount data that differs from the predicted revenue amount may also be used to re-train the machine learning model used by predictive revenue service 112. For example, if the actual transaction amount is greater than or less than the predicted revenue amount, the machine learning model may be re-trained to account for the difference. This may lead to more accurate predictions for subsequent determinations of the predicted revenue amount.

In some embodiments, revenue distribution system 110 may interface with aggregator merchants. An aggregator merchant may provide services for other merchants. For example, smaller businesses may avoid individually signing up for access to multiple credit card services by instead signing up with an aggregator merchant. The smaller businesses may rely on an aggregator merchant API to manage checkout transactions. The aggregator merchant may also host inventory information and/or allow a smaller business to create a webpage. Revenue distribution system 110 may interface with aggregator merchants to provide similar predictive revenue services. This may occur as a lump sum to an aggregator. The aggregator may then apportion the predicted revenue amount to the smaller businesses. In some embodiments, the aggregator merchants may provide individual small business data to revenue distribution system 110. In this case, revenue distribution system 110 may individually generate predicted revenue amounts and/or provide this to the smaller businesses individually.

In some embodiments, revenue distribution system 110 may charge the merchant account for the predictive revenue functionality. For example, revenue distribution system 110 may charge a 1% or 2% fee based on the predicted revenue amount. In some embodiments, revenue distribution system 110 may implemented a tiered pricing option. This may be based on the amount of data records and/or confidence that revenue distribution system 110 has for a particular merchant account. For example, if the quantity of data records is below a threshold, the fee for determining and depositing the predicted revenue amount may be higher. As more transaction amount data is accumulated, however, the fee may be lowered. In some embodiments, the fee may be tiered based on a confidence level determined by the machine learning algorithm. In some embodiments, revenue distribution system 110 may allow a merchant to request an advance and/or a loan further into the future. A fee may be generated based on the amount of time that the merchant is requesting for the advanced amount.

FIG. 2 depicts a flowchart illustrating a method 200 for generating and depositing a predicted revenue amount, according to some embodiments. Method 200 shall be described with reference to FIG. 1; however, method 200 is not limited to that example embodiment.

In an embodiment, revenue distribution system 110 may utilize method 200 to generate a predicted revenue amount and deposit the predicted revenue amount into a merchant account. As previously explained, this may occur prior to a merchant completing transactions totaling the predicted revenue amount. The foregoing description will describe an embodiment of the execution of method 200 with respect to revenue distribution system 110. While method 200 is described with reference to revenue distribution system 110, method 200 may be executed on any computing device, such as, for example, the computer system described with reference to FIG. 6 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 2, as will be understood by a person of ordinary skill in the art.

At 205, revenue distribution system 110 may determine that a merchant account has opted to receive predictive revenue deposits. The merchant account may correspond to merchant system 140. In some embodiments, merchant system 140 may have previously been receiving funding from revenue distribution system 110 which may have been settled following transaction completion. For example, this may include batch settlement occurring at the end of each day. At 205, merchant system 140 may request that revenue distribution system 110 provide predictive revenue deposits. For example, this may occur via an online form and/or dashboard accessible by merchant system 140.

At 210, revenue distribution system 110 may generate a predicted revenue amount by applying a machine learning algorithm to a set of transaction records corresponding to the merchant account. For example, revenue distribution system 110 may have previously stored transaction records in merchant record database 116. Revenue distribution system 110 may have trained the machine learning algorithm using such records to generate a predicted revenue amount corresponding to a given time period. For example, the machine learning algorithm may have been trained to provide a predicted revenue amount corresponding to a calendar date and/or a range of dates. As previously explained, the training may account for the historical transaction records provided by merchant system 140 and/or other patterns. For example, the machine learning model may also consider factors including the industry of business for the merchant, seasonal patterns of reported revenue, temperature, weather, geography, and/or other factors. The machine learning model may also consider records of other similar merchants and/or customer records. For example, records of other similar merchants and/or customer records may be accessed to supplement the merchant records and/or if there are too few merchant records. In this manner, revenue distribution system 110 may train the machine learning algorithm using a set of transaction records corresponding to a merchant account to generate a predicted revenue amount for a time period, wherein the set of transaction records correlates a plurality of time periods with respective transaction amounts. Revenue distribution system 110 may also generate a predicted revenue amount for a specified time period by applying the specified time period to the machine learning algorithm.

At 215, revenue distribution system 110 may transfer the predicted revenue amount to the merchant account via RTP network 120. Revenue distribution system 110 may use an API to connect to and access banking systems 130 via the RTP network 120. Revenue distribution system 110 may use RTP network 120 to direct funding from an account corresponding to revenue distribution system 110 into an account corresponding to merchant system 140. For example, if the revenue distribution system 110 account corresponds to banking system 130A and the merchant account corresponds to banking system 130B, revenue distribution system 110 may direct a transfer from banking system 130A to banking system 130B. Revenue distribution system 110 may specify the appropriate account numbers for this transfer. As previously explained, revenue distribution system 110 may transfer this funding prior to transactions being completed by merchant system 140. For example, this may occur at the beginning of the day and/or on a previous day. In this manner, the merchant using merchant system 140 may have faster access to funding.

At 220, revenue distribution system 110 may receive a transaction amount from merchant system 140 corresponding to the merchant account. The transaction amount may correspond to actual transaction amounts logged by merchant system 140. In some embodiments, the transaction amount may correspond to the time period specified for the predicted revenue amount. For example, if the predicted revenue amount is for a particular day, the transaction amount may be the actual transaction amount recorded by merchant system 140 for that day. The transaction amount may include an aggregation of transaction records for the merchant. For example, this may be transaction records for the day's transactions. In some embodiments, revenue distribution system 110 may receive multiple transaction amounts and/or aggregate these values to determine a transaction amount corresponding to a predicted revenue amount. For example, if the predicted revenue amount is for a range of days, revenue distribution system 110 may receive several transaction amounts and/or aggregate such amounts for the range of days.

At 225, revenue distribution system 110 may determine whether the transaction amount matches the predicted revenue amount. For example, revenue distribution system 110 may compare the transaction amount to the predicted revenue amount for the particular time period designated. At 230, if the transaction amount matches the predicted revenue amount, revenue distribution system 110 may confirm its prediction. At 240, revenue distribution system 110 may add the transaction amount to the set of transaction records. This may include storing the transaction amount in merchant record database 116. Additionally, revenue distribution system 110 may also store other information correlated with the transaction amount. For example, revenue distribution system 110 may store the date with the transaction amount and/or other factors such as the weather or temperature to measure seasonality affects. At 245, revenue distribution system 110 may re-train the machine learning algorithm based on the transaction amount. This may provide for more accurate determinations of a predicted revenue amount.

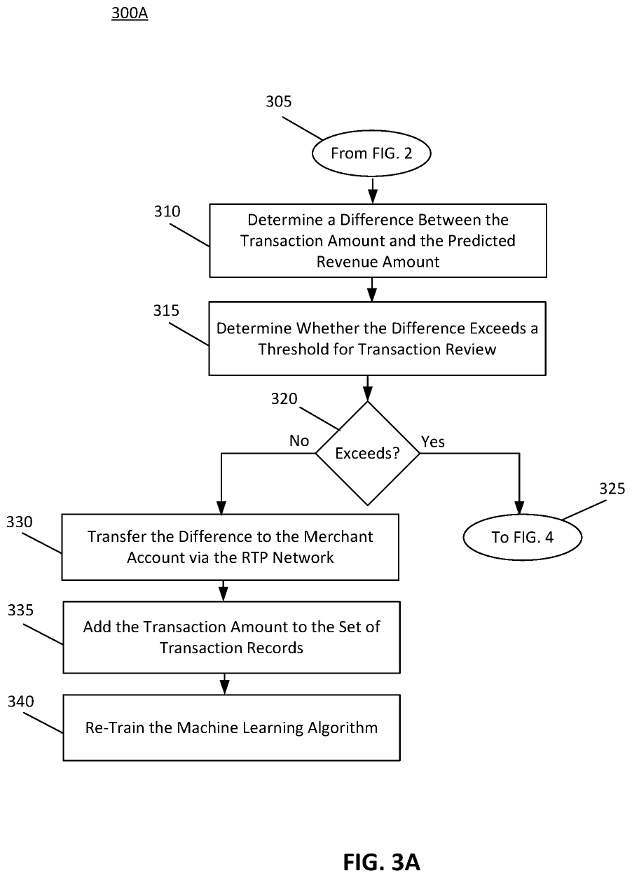

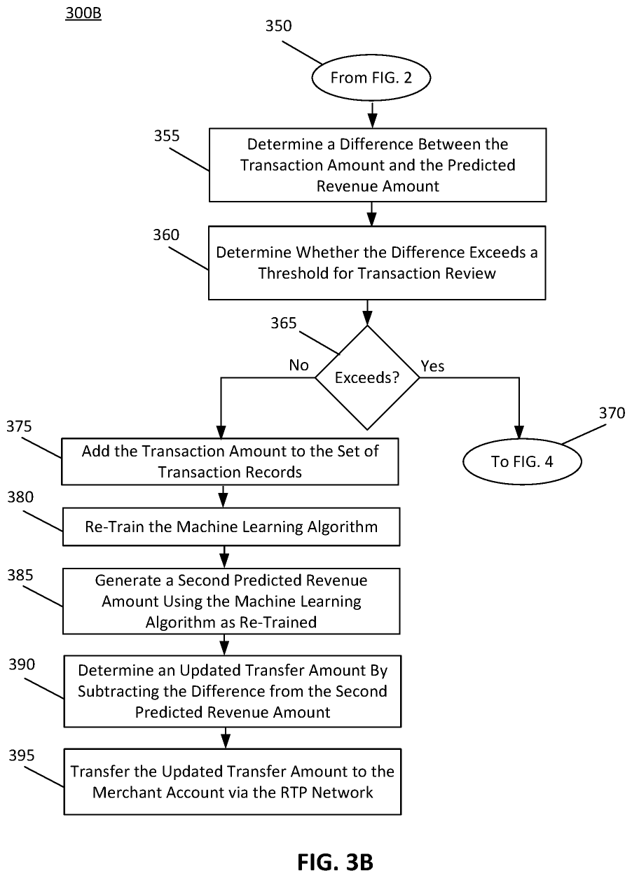

Returning to 230, if the transaction amount does not match the predicted revenue amount, revenue distribution system 110 may proceed to 235. At 235, revenue distribution system 110 may determine whether the transaction amount is greater than or less than the predicted revenue amount. At 250, if the transaction amount is greater than the predicted revenue amount, revenue distribution system 110 may proceed to the operations described with reference to FIG. 3A as indicated at 255. If the transaction amount is less than the predicted revenue amount, revenue distribution system 110 may proceed to the operations described with reference to FIG. 3B as indicated at 260.

FIG. 3A depicts a flowchart illustrating a method 300A for processing a transaction amount that is greater than a predicted revenue amount, according to some embodiments. Method 300A shall be described with reference to FIG. 1; however, method 300A is not limited to that example embodiment.

In an embodiment, revenue distribution system 110 may utilize method 300A to process transaction amounts recorded as being greater than a predicted revenue amount. For example, a predicted revenue amount may have been previously deposited in a merchant account based on a particular time period. The actual transaction amount collected by the merchant account, however, may be greater than the predicted revenue amount. The foregoing description will describe an embodiment of the execution of method 300A with respect to revenue distribution system 110. While method 300A is described with reference to revenue distribution system 110, method 300A may be executed on any computing device, such as, for example, the computer system described with reference to FIG. 6 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 3A, as will be understood by a person of ordinary skill in the art.

At 305, revenue distribution system 110 may have determined that a transaction amount received from a merchant system 140 is greater than a predicted revenue amount. This process was previously described with reference to FIG. 2.

At 310, revenue distribution system 110 may determine a difference between the transaction amount and the predicted revenue amount. This difference may correspond to a particular time period given for the predicted revenue amount. For example, if revenue distribution system 110 previously generated a predicted revenue amount of $1,000 for a particular day, the transaction amount may correspond to the actual revenue collected for that day. For example, the transaction amount may be $1,200. At 310, revenue distribution system 110 may determine that the difference is $200. In this manner, revenue distribution system 110 may calculate a difference between the transaction amount and the predicted revenue amount.

At 315, revenue distribution system 110 may determine whether the difference exceeds a threshold for transaction review. For example, revenue distribution system 110 may have been configured with one or more rules for fraud detection. When a merchant system 140 reports a transaction amount that exceeds the predicted revenue amount by a large quantity, revenue distribution system 110 may flag the transaction amount and/or corresponding transaction data for further review. In some embodiments, the comparison with the threshold may be a particular value and a determination of whether the value exceeds the threshold. In some embodiments, the comparison may be based on a percentage and/or use a percentage threshold. For example, a percentage threshold may be set at 50% and revenue distribution system 110 may determine whether the difference is more than 50% greater than the predicted revenue amount.

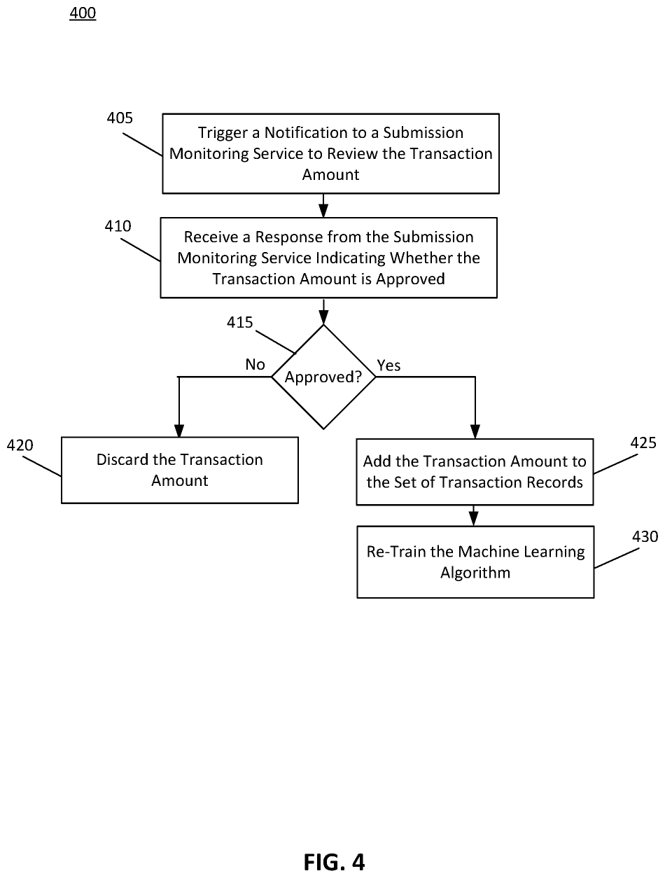

At 320, revenue distribution system 110 may determine whether the difference exceeds the threshold. If the difference exceeds the threshold, revenue distribution system 110 may proceed to the operations described with reference to FIG. 4 at 325. This may occur when the transaction amount is an outlier to a pattern of transaction data previously provided by the merchant system 140. If the difference does not exceed the threshold, revenue distribution system 110 may proceed to 330. In some embodiments, the determination that the difference does not exceed the threshold may indicated that the difference falls within an acceptable tolerance and that additional fraud detection review is not needed.

At 330, revenue distribution system 110 may transfer the difference to the merchant account via the RTP network 120. This transfer may occur in a manner similar to 215 as described with reference to FIG. 2. For example, if the difference is determined to be $200, revenue distribution system 110 may deposit this amount in the merchant account. In some embodiments, this may occur at the end of the day and/or the following day. In this case, the merchant may have still received some of its earnings based on the predicted revenue amount without needing to wait for this additional settlement.

At 335, revenue distribution system 110 may add the transaction amount to the set of transaction records. At 340, revenue distribution system 110 may re-train the machine learning algorithm. These processes may occur in a manner similar to 240 and 245 as described with reference to FIG. 2. For example, additional data may be stored and used to aid in re-training the machine learning algorithm to provide more accurate predictions.

FIG. 3B depicts a flowchart illustrating a method 300B for processing a transaction amount that is less than a predicted revenue amount, according to some embodiments. Method 300B shall be described with reference to FIG. 1; however, method 300B is not limited to that example embodiment.

In an embodiment, revenue distribution system 110 may utilize method 300B to process transaction amounts recorded as being less than a predicted revenue amount. For example, a predicted revenue amount may have been previously deposited in a merchant account based on a particular time period. The actual transaction amount collected by the merchant account, however, may be less than the predicted revenue amount. The foregoing description will describe an embodiment of the execution of method 300B with respect to revenue distribution system 110. While method 300B is described with reference to revenue distribution system 110, method 300B may be executed on any computing device, such as, for example, the computer system described with reference to FIG. 6 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 3B, as will be understood by a person of ordinary skill in the art.

At 350, revenue distribution system 110 may have determined that a transaction amount received from a merchant system 140 is less than a predicted revenue amount. This process was previously described with reference to FIG. 2.

At 355, revenue distribution system 110 may determine a difference between the transaction amount and the predicted revenue amount. This difference may correspond to a particular time period given for the predicted revenue amount. For example, if revenue distribution system 110 previously generated a predicted revenue amount of $1,000 for a particular day, the transaction amount may correspond to the actual revenue collected for that day. For example, the transaction amount may be $800. At 355, revenue distribution system 110 may determine that the difference is $200. In this manner, revenue distribution system 110 may calculate a difference between the transaction amount and the predicted revenue amount.

At 360, revenue distribution system 110 may determine whether the difference exceeds a threshold for transaction review. In some embodiments, revenue distribution system 110 may characterize this as a potential fraud scenario based on rules stored in revenue distribution system 110. This may trigger a fraud detection review similar to 315 as described with reference to FIG. 3B. In some embodiments, the detection of the difference exceeding a threshold may indicate poor business performance. In this case, revenue distribution system 110 may store and/or log this performance. Revenue distribution system 110 may track trends and/or determine whether such a difference generates a pattern of poor business performance. In this case, revenue distribution system 110 may notify merchant system 140. In some embodiments, revenue distribution system 110 may notify a client manager, a merchant partnership manager, and/or another staff member. For example, revenue distribution system 110 may generate a message sent to an email account and/or user account corresponding to such roles.

In some embodiments, the comparison with the threshold at 360 may be a particular value and a determination of whether the value exceeds the threshold. For example, the merchant system 140 reports earnings of $200 less than the predicted revenue amount while the threshold may be $500. In some embodiments, the comparison may be based on a percentage and/or use a percentage threshold. For example, a percentage threshold may be set at 30% and revenue distribution system 110 may determine whether the difference is more than 30% below than the predicted revenue amount. The threshold described with reference to FIG. 3B may or may not differ from the threshold described with reference to FIG. 3A.

At 365, revenue distribution system 110 may determine whether the difference exceeds the threshold. If the difference exceeds the threshold, revenue distribution system 110 may proceed to the operations described with reference to FIG. 4 at 370. If the difference does not exceed the threshold, revenue distribution system 110 may proceed to 375. In some embodiments, the determination that the difference does not exceed the threshold may indicated that the difference falls within an acceptable tolerance and that additional fraud detection review or merchant notification is not needed.

At 375, revenue distribution system 110 may add the transaction amount to the set of transaction records. At 380, revenue distribution system 110 may re-train the machine learning algorithm. These processes may occur in a manner similar to 240 and 245 as described with reference to FIG. 2. For example, additional data may be stored and used to aid in re-training the machine learning algorithm to provide more accurate predictions. At 385, revenue distribution system 110 may generate a second predicted revenue amount using the machine learning algorithm as re-trained. The second predicted revenue amount may correspond to a subsequent time period. For example, the second predicted revenue amount may correspond to the following day. To generate this predicted revenue amount, revenue distribution system 110 may apply the re-trained machine learning algorithm to the particular date and/or range of dates specified.

At 390, revenue distribution system 110 may determine an updated transfer amount by subtracting the difference from the second predicted revenue amount. This process may account for the revenue distribution system 110 providing more funds during the previous time period relative to the transaction amount that the merchant system 140 reported for that time period. For example, a predicted revenue amount for a first day may be $1,000 but the transaction amount for that first day may be $800. In this manner, the difference is $200 less than the predicted revenue amount. Revenue distribution system 110, however, may have already deposited $1,000 in the merchant account. To account for the difference, revenue distribution system 110 may subtract the $200 different from the second day's predicted revenue amount. For example, revenue distribution system 110 may determine the second predicted revenue amount as being $1,100. To account for the first day's difference, revenue distribution system 110 may calculate the updated transfer amount as being $900. In this manner, revenue distribution system 110 may calculate an updated transfer amount by subtracting the difference from the second predicted revenue amount.

At 395, revenue distribution system 110 may transfer the updated transfer amount to the merchant account via RTP network 120. This transfer may occur in a manner similar to 215 as described with reference to FIG. 2.

FIG. 4 depicts a flowchart illustrating a method 400 for triggering a transaction review, according to some embodiments. Method 400 shall be described with reference to FIG. 1; however, method 400 is not limited to that example embodiment.

In an embodiment, revenue distribution system 110 may utilize method 400 to trigger a transaction review. This may occur prior when a difference between a predicted revenue amount and an actual transaction amount exceeds a threshold. For example, this may trigger a review to determine that fraud is not occurring. The foregoing description will describe an embodiment of the execution of method 400 with respect to revenue distribution system 110. While method 400 is described with reference to revenue distribution system 110, method 400 may be executed on any computing device, such as, for example, the computer system described with reference to FIG. 6 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 4, as will be understood by a person of ordinary skill in the art.

As previously explained, the operations described with reference to FIG. 4 may occur in response to a determination that the difference between the actual transaction amount and the predicted revenue amount exceeds a threshold. This may occur when the actual transaction amount is greater (as described with reference to FIG. 3A and 325) and/or may occur when the actual transaction amount is less (as described with reference to FIG. 3B and 370). In either scenario, revenue distribution system 110 may proceed to the operations described with reference to FIG. 4.

At 405, revenue distribution system 110 may trigger a notification to submission monitoring service 114 to review the transaction amount. For example, submission monitoring service 114 may generate a GUI notification and/or a message to an administrator of revenue distribution system 110 to review the transaction amount and/or corresponding transaction data provided by merchant system 140. For example, the transaction amount may include an aggregation of transaction records for the merchant. For example, this may be transaction records for the day's transactions. Revenue distribution system 110 may provide a GUI with icons, text boxes, and/or other GUI objects allowing an administrator to provide approval and/or denial of the transaction amount. In some embodiments, submission monitoring service 114 may provide this information to an external system for review.

At 410, revenue distribution system 110 may receive a response from the submission monitoring service 114 indicating whether the transaction amount is approved. For example, an administrator may interact with the GUI to provide approval or rejection of the transaction. Approval may correspond to an indication that fraudulent activity has not been detected. In contrast, the administrator may deny the transaction amount if fraudulent activity is suspected.

At 415, if the transaction is approved, revenue distribution system 110 may proceed to 425. At 425, revenue distribution system 110 may add the transaction amount to the set of transaction records. At 430, revenue distribution system 110 may re-train the machine learning algorithm. These processes may occur in a manner similar to 240 and 245 as described with reference to FIG. 2. For example, additional data may be stored and used to aid in re-training the machine learning algorithm to provide more accurate predictions.

Returning to 415, if the transaction is not approved and/or is denied, revenue distribution system 110 may proceed to 420. At 420, revenue distribution system 110 may discard the transaction amount. In this case, revenue distribution system 110 may identify the merchant account as potentially experiencing fraudulent activity. Revenue distribution system 110 may then not store and/or use the transaction data to update the machine learning algorithm. In some embodiments, revenue distribution system 110 may also designate the merchant account as locked. For example, revenue distribution system 110 may cease predictive revenue deposits to the merchant account until correction is provided. In some embodiments, revenue distribution system 110 may perform a chargeback and/or remove funding from the merchant account if a transaction amount is not approved. In this manner, revenue distribution system 110 may provide actions for addressing potentially fraudulent activity.

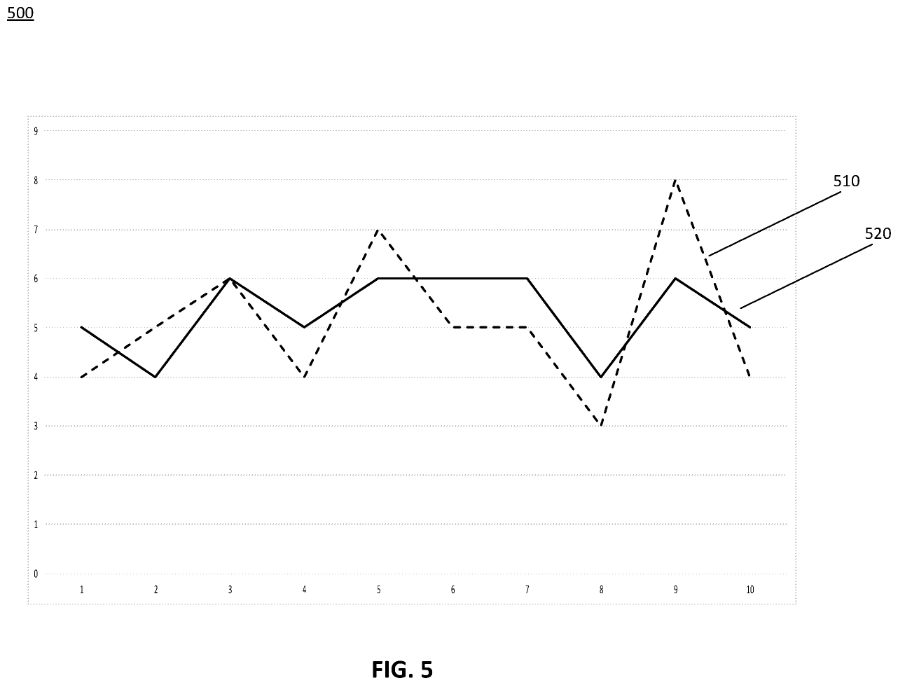

FIG. 5 depicts a block diagram of a graphical user interface (GUI) 500 displaying revenue trends, according to some embodiments. GUI 500 may be generated by revenue distribution system 110 and/or displayed via merchant system 140. For example, GUI 500 may be a screen accessible by merchant system 140 via an application and/or web browser. In some embodiments, merchant system 140 may access a website and/or webpage to view GUI 500. Revenue distribution system 110 may provide GUI data objects and/or data to merchant system 140 to display GUI 500.

GUI 500 may provide a visual representation of revenue trends and/or analytics for a merchant. For example, GUI 500 may include a graph displaying a predicted revenue amount trend 510 and/or a transaction amount trend 520. In some embodiments, these may be line graphs. The horizontal axis may be time value or time period, such as a particular calendar day. The vertical axis may be an amount of revenue, which may be expressed in dollars. With GUI 500, a merchant may view business performance and/or determine the accuracy of the predicted revenue amount. In some embodiments, GUI 500 may provide a forecast for an extended time period to allow a merchant to view predicted revenue amounts for future dates. This may allow the merchant to plan for receiving the predicted revenue amounts and budget accordingly.

In some embodiments, GUI 500 may provide an indicator of poor business performance if predicted revenue amount trend 510 and/or transaction amount trend 520 demonstrates a decline in revenue. Merchants may then be notified of possible issues and/or take corrective action based on trends 510, 520 and/or projected revenue amounts. In some embodiments, a client manager, a merchant partnership manager, and/or another staff member may be notified. For example, revenue distribution system 110 may generate a message sent to an email account and/or user account corresponding to such roles. In some embodiments, the message may include trends 510, 520, data, and/or projected revenue amounts. This may allow merchants and/or staff members to take appropriate next steps and/or corrective action.

Various embodiments may be implemented, for example, using one or more well-known computer systems, such as computer system 600 shown in FIG. 6. One or more computer systems 600 may be used, for example, to implement any of the embodiments discussed herein, as well as combinations and sub-combinations thereof.

Computer system 600 may include one or more processors (also called central processing units, or CPUs), such as a processor 604. Processor 604 may be connected to a communication infrastructure or bus 606.

Computer system 600 may also include user input/output device(s) 603, such as monitors, keyboards, pointing devices, etc., which may communicate with communication infrastructure 606 through user input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer implemented method, comprising:
training a machine learning algorithm using a set of transaction records corresponding to a merchant account to generate a predicted revenue amount for a time period, wherein the set of transaction records correlates a plurality of time periods with respective transaction amounts;
generating a predicted revenue amount for a specified time period by applying the specified time period to the machine learning algorithm;
transferring the predicted revenue amount to the merchant account via a Real-Time Payment (RTP) network;
in response to transferring the predicted revenue amount, receiving a transaction amount corresponding to the merchant account;
determining whether the transaction amount matches the predicted revenue amount;
updating the set of transaction records to include the transaction amount; and
re-training the machine learning algorithm using the transaction amount.

2. The computer implemented method of claim 1, wherein determining whether the transaction amount matches the predicted revenue amount further comprises:
determining that the transaction amount is greater than the predicted revenue amount;
calculating a difference between the transaction amount and the predicted revenue amount; and
transferring the difference to the merchant account via the RTP network.

3. The computer implemented method of claim 1, wherein determining whether the transaction amount matches the predicted revenue amount further comprises:
determining that the transaction amount is less than the predicted revenue amount;
calculating a difference between the transaction amount and the predicted revenue amount;
generating a second predicted revenue amount using the machine learning algorithm as re-trained;
calculating an updated transfer amount by subtracting the difference from the second predicted revenue amount; and
transferring the updated transfer amount to the merchant account via the RTP network.

4. The computer implemented method of claim 1, wherein determining whether the transaction amount matches the predicted revenue amount further comprises:
determining that the transaction amount differs from the predicted revenue amount;
calculating a difference between the transaction amount and the predicted revenue amount;
determining that the difference exceeds a threshold for transaction review; and
generating a notification message requesting review of the transaction amount.

5. The computer implemented method of claim 1, wherein the predicted revenue amount corresponds to a first calendar date, the method further comprising:
generating a second predicted revenue amount using the machine learning algorithm as re-trained, wherein the second predicted revenue amount corresponds to a second calendar date; and
transferring the second predicted revenue amount to the merchant account via the RTP network on the second calendar date.

6. The computer implemented method of claim 1, wherein the predicted revenue amount corresponds to a first range of calendar dates, the method further comprising:
generating a second predicted revenue amount using the machine learning algorithm as re-trained, wherein the second predicted revenue amount corresponds to a second range of calendar dates; and
transferring the second predicted revenue amount to the merchant account via the RTP network within the second range of calendar dates.

7. The computer implemented method of claim 1, wherein training the machine learning algorithm further comprises:
training the machine learning algorithm using a second set of transaction records corresponding to a second merchant account.

8. A system, comprising:
a memory; and
at least one processor coupled to the memory and configured to:
train a machine learning algorithm using a set of transaction records corresponding to a merchant account to generate a predicted revenue amount for a time period, wherein the set of transaction records correlates a plurality of time periods with respective transaction amounts;
generate a predicted revenue amount for a specified time period by applying the specified time period to the machine learning algorithm;
transfer the predicted revenue amount to the merchant account via a Real-Time Payment (RTP) network;
in response to transferring the predicted revenue amount, receive a transaction amount corresponding to the merchant account;
determine whether the transaction amount matches the predicted revenue amount;
update the set of transaction records to include the transaction amount; and
re-train the machine learning algorithm using the transaction amount.

9. The system of claim 8, wherein to determine whether the transaction amount matches the predicted revenue amount, the at least one processor is further configured to:
determine that the transaction amount is greater than the predicted revenue amount;
calculate a difference between the transaction amount and the predicted revenue amount; and
transfer the difference to the merchant account via the RTP network.

10. The system of claim 8, wherein to determine whether the transaction amount matches the predicted revenue amount, the at least one processor is further configured to:
determine that the transaction amount is less than the predicted revenue amount;
calculate a difference between the transaction amount and the predicted revenue amount;
generate a second predicted revenue amount using the machine learning algorithm as re-trained;
calculate an updated transfer amount by subtracting the difference from the second predicted revenue amount; and
transfer the updated transfer amount to the merchant account via the RTP network.

11. The system of claim 8, wherein to determine whether the transaction amount matches the predicted revenue amount, the at least one processor is further configured to:
determine that the transaction amount differs from the predicted revenue amount;
calculate a difference between the transaction amount and the predicted revenue amount;
determine that the difference exceeds a threshold for transaction review; and
generate a notification message requesting review of the transaction amount.

12. The system of claim 8, wherein the predicted revenue amount corresponds to a first calendar date and wherein the at least one processor is further configured to:
generate a second predicted revenue amount using the machine learning algorithm as re-trained, wherein the second predicted revenue amount corresponds to a second calendar date; and
transfer the second predicted revenue amount to the merchant account via the RTP network on the second calendar date.

13. The system of claim 8, wherein the predicted revenue amount corresponds to a first range of calendar dates and wherein the at least one processor is further configured to:
generate a second predicted revenue amount using the machine learning algorithm as re-trained, wherein the second predicted revenue amount corresponds to a second range of calendar dates; and
transfer the second predicted revenue amount to the merchant account via the RTP network within the second range of calendar dates.

14. The system of claim 8, wherein to train the machine learning algorithm, the at least one processor is further configured to:
train the machine learning algorithm using a second set of transaction records corresponding to a second merchant account.

15. A non-transitory computer-readable device having instructions stored thereon that, when executed by at least one computing device, cause the at least one computing device to perform operations comprising:
training a machine learning algorithm using a set of transaction records corresponding to a merchant account to generate a predicted revenue amount for a time period, wherein the set of transaction records correlates a plurality of time periods with respective transaction amounts;
generating a predicted revenue amount for a specified time period by applying the specified time period to the machine learning algorithm;
transferring the predicted revenue amount to the merchant account via a Real-Time Payment (RTP) network;
in response to transferring the predicted revenue amount, receiving a transaction amount corresponding to the merchant account;
determining whether the transaction amount matches the predicted revenue amount;
updating the set of transaction records to include the transaction amount; and
re-training the machine learning algorithm using the transaction amount.

16. The non-transitory computer-readable device of claim 15, wherein determining whether the transaction amount matches the predicted revenue amount further comprises:
determining that the transaction amount is greater than the predicted revenue amount;
calculating a difference between the transaction amount and the predicted revenue amount; and
transferring the difference to the merchant account via the RTP network.

17. The non-transitory computer-readable device of claim 15, wherein determining whether the transaction amount matches the predicted revenue amount further comprises:
determining that the transaction amount is less than the predicted revenue amount;
calculating a difference between the transaction amount and the predicted revenue amount;
generating a second predicted revenue amount using the machine learning algorithm as re-trained;
calculating an updated transfer amount by subtracting the difference from the second predicted revenue amount; and
transferring the updated transfer amount to the merchant account via the RTP network.

18. The non-transitory computer-readable device of claim 15, wherein determining whether the transaction amount matches the predicted revenue amount further comprises:
determining that the transaction amount differs from the predicted revenue amount;
calculating a difference between the transaction amount and the predicted revenue amount;
determining that the difference exceeds a threshold for transaction review; and
generating a notification message requesting review of the transaction amount.

19. The non-transitory computer-readable device of claim 15, wherein the predicted revenue amount corresponds to a first calendar date, the operations further comprising:
generating a second predicted revenue amount using the machine learning algorithm as re-trained, wherein the second predicted revenue amount corresponds to a second calendar date; and
transferring the second predicted revenue amount to the merchant account via the RTP network on the second calendar date.

20. The non-transitory computer-readable device of claim 15, wherein training the machine learning algorithm further comprises:
training the machine learning algorithm using a second set of transaction records corresponding to a second merchant account.
